(19) United States
(12) Patent Application Publication
(10) Pub. No.: US 2007/0132705 A1
(43) Pub. Date: Jun. 14, 2007

(54) Display device and method for correlating pixel updates with pixel illumination

(76) Inventors: Chin Hin Oon, Penang (MY); Ken A. Nishimura, Fremont, CA (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/299,881

(22) Filed: Dec. 12, 2005

(51) Int. Cl. G09G 3/36

(52) U.S. Cl. 345/102

(57) ABSTRACT

A display device reduces artifacts in displayed images using an illumination device that includes light sources for emitting light and an illumination drive circuit operable to individually modulate each of the light sources. Electro-optical elements defining pixels of an image are each optically coupled to receive light correlated with one of the light sources. A controller loads data representing a portion of the image into those electro-optical elements that are correlated with a modulated one of the light sources modulated to reduce the intensity thereof.

### BACKGROUND OF THE INVENTION

Traditional display devices typically include an array of light valves disposed between a light source and an observer. For monochrome displays, the light source (e.g., CCFL light source) provides a uniform distribution of light, which is selectively passed by the individual light valves to produce the monochrome image. Multi-color displays are achieved by interposing a color filter array between the light source and the array of light valves, such that the light entering each light valve is preselected in wavelength. For example, a common color filter array used in display devices is a checkerboard pattern of red, green and blue filters.

In liquid crystal display (LCD) devices, such as those used in laptop computers and flat panel televisions, the light valves are formed from liquid crystal material disposed between a substrate and a glass cover. Individual light valves, hereinafter referred to as “electro-optical elements,” defming pixels of an image are created by forming a common electrode on the substrate and patterning a matrix of pixel electrodes on the glass cover. The liquid crystal material reacts in response to electric fields established between the common electrode and pixel electrodes to control the electro-optical response of each of the electro-optical elements.

For example, the pixel electrodes in LCD devices are typically driven by a matrix of thin film transistors (TFTs). Each TFT individually addresses a respective pixel electrode to load data representing a pixel of an image into the pixel electrode. The loaded data produces a corresponding voltage on the pixel electrode. Depending on the voltages applied between the pixel electrode and the common electrode, the liquid crystal material reacts at that pixel to either change or not change the polarization state of incoming light. In some applications, the pixel electrodes can be driven with voltages that create a partial reaction of the liquid crystal material so that the pixel is in a non-binary state (i.e., not fully ON or OFF) to produce a “gray scale” transmission.

However, one of the inherent weaknesses of LCD devices is the slow response time of the liquid crystal material between data updates relative to changes in the displayed image. The slow response time can produce artifacts in the image. Such artifacts are often experienced as blurring of fast moving objects on the display. For example, when new data is loaded into a pixel electrode for a new image frame, there is a “settling period” during which time the liquid crystal material is changing in reaction to the applied electric field. During these “settling periods,” the state of the liquid crystal material is not uniform, which causes the artifacts to appear. Therefore, what is needed is display device for reducing artifacts in images.

### SUMMARY OF THE INVENTION

Embodiments of the present invention provide a display device for reducing artifacts in an image using an illumination device that includes light sources for emitting light and an illumination drive circuit operable to individually modulate each of the light sources. Electro-optical elements defining pixels of an image are each optically coupled to receive light correlated with one of the light sources. A controller loads data representing a portion of the image into those electro-optical elements that are correlated with a modulated one of the light sources modulated to reduce the intensity thereof.

In one embodiment, the illumination device also includes a respective waveguide for each of the light sources, in which each of the waveguides defines respective optical apertures spatially arranged in a respective predetermined pattern to produce a respective spatial pattern of light. The controller is operable to load data into the electro-optical elements that are optically coupled to receive the spatial pattern of light corresponding to the modulated light source. For example, in an exemplary embodiment, the light sources include a red light emitting diode (LED), a green LED and a blue LED. The controller loads data into the electro-optical elements that are optically coupled to receive light from the red LED when the red LED is modulated, and similarly for the green and blue LED's.

In another embodiment, the display device further includes an array of color filters, each for transmitting light at one of a predetermined number of wavelength ranges. The color filters are spatially arranged in a predetermined pattern to produce a spatial pattern of light at wavelengths corresponding to the predetermined pattern. In addition, each of the light sources emits light at one of the wavelength ranges to produce a uniform field of light optically received at the color filters. Furthermore, the electro-optical elements are spatially arranged in the same predetermined pattern to receive the spatial pattern of light. The controller loads data into those electro-optical elements that are optically coupled to receive light at one of the wavelength ranges corresponding to the modulated light source.

For example, in an exemplary embodiment, the light sources again include a red LED, a green LED and a blue LED, and the color filters include green filters operable to transmit green light, blue filters operable to transmit blue light and red filters operable to transmit red light. The controller loads data into the electro-optical elements that are optically coupled to receive red light when the red LED is modulated, and similarly for the blue LED and green LED.

In yet another embodiment, the electro-optical elements are spatially arranged in a plurality of zones, and each of the light sources is optically coupled to illuminate one of the zones. The controller loads data into the electro-optical elements within the zone that is optically coupled to receive light from the modulated light source.

Embodiments of the present invention further provide a method for correlating updates to pixels on a display with illumination of the pixels on the display. The method includes correlating light sources with electro-optical elements defining pixels of an image. The method further includes modulating one of the light sources to reduce the intensity thereof and loading data representing a portion of the image into the electro-optical elements that are correlated with the modulated light source.

### BRIEF DESCRIPTION OF THE DRAWINGS

The disclosed invention will be described with reference to the accompanying drawings, which show sample embodiments of the invention and which are incorporated in the specification hereof by reference, wherein:

FIG. 1 is a pictorial representation of an exemplary display device capable of reducing artifacts in images, in accordance with embodiments of the present invention;

FIG. 2 is an exploded view of another exemplary liquid crystal display device capable of reducing artifacts in images, in accordance with embodiments of the present invention;

FIG. 3 is a pictorial representation of yet another exemplary display device capable of reducing artifacts in images, in accordance with embodiments of the present invention; and

FIG. 4 is a flow chart illustrating an exemplary process for correlating updates to pixels on a display with illumination of the pixels on the display to reduce artifacts in images, in accordance with embodiments of the present invention.

### DETAILED DESCRIPTION OF EXEMPLARY EMBODIMENTS

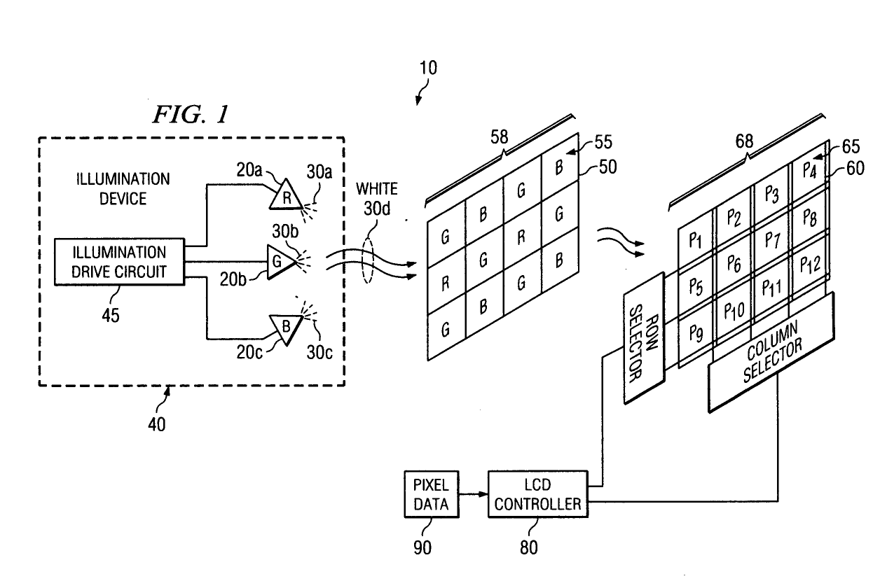

FIG. 1 is a pictorial representation of an exemplary display device 10 capable of reducing artifacts in images displayed thereon, in accordance with embodiments of the present invention. The display device 10 includes an illumination device 40 and a liquid crystal device 60. Between the illumination device 40 and the liquid crystal device 60 is a color filter array (CFA) 50 formed of a number of color filters 55. Each color filter 55 is designed to absorb light within a particular wavelength range in order to pass light in other wavelength ranges. For example, a red color filter 55 absorbs green and blue light and passes red light, a blue color filter 55 absorbs red and green light and passes and blue light and a green color filter 55 absorbs red light and passes green and blue light. A common CFA 50 used in display devices 10 is a checkerboard pattern 58 of red, green and blue filters, as shown in FIG. 1.

The illumination device 40 includes light sources 20a, 20b and 20c for emitting light. In FIG. 1, each of the light sources 20a, 20b and 20c is operable to output light in a different wavelength range of the visible light spectrum. For example, in one embodiment, light source 20a emits blue light 30a, light source 20b emits red light 30b and light source 20c emits green light 30c. In an exemplary embodiment, light sources 20a, 20b and 20c are light emitting diodes (LEDs). The light 30a, 30b and 30c output from light sources 20a, 20b and 20c is mixed to produce a uniform field of white light 30d that is optically received by the color filter array 50. Each color filter 55 in the CFA 50 filters the light 30d in a particular wavelength range to pass light of a particular color, such as red, green or blue. The illumination device 40 further includes an illumination drive circuit 45 capable of individually modulating each of the light sources 20a, 20b and 20c. As used herein, the term “modulate” refers to varying the intensity of the light emitted from a light source. For example, the illumination drive circuit 45 may blink (or turn off) the LED, dim the LED or otherwise vary the intensity of the LED.

The liquid crystal device 60 includes a two-dimensional array of electro-optical elements 65 forming pixels (P1-P12) of an image. The electro-optical elements 65 are spatially arranged in a pattern 68 corresponding to the pattern 58 of color filters 55 in the CFA 50, such that each electro-optical element 65 is optically coupled to receive light from only one color filter 55. In one embodiment, each color filter 55 optically couples light of a particular wavelength (e.g., blue, green or red) to only a single electro-optical element 65. For example, in FIG. 1, pixel P1 in the top-left corner of the array is optically coupled to receive green light from the top-left green color filter, pixel P2 is optically coupled to receive blue light from the blue color filter horizontally-adjacent the top-left green color filter, and pixel P5 is optically coupled to receive red light from the red color filter vertically-adjacent the top-left green color filter.

The electro-optical elements 65 are individually controlled by an LCD controller 80 to load pixel data 90 representing an image frame into the electro-optical elements 65. Row selector 70 and column selector 75 select the rows and columns of the array, respectively, to load the data into the electro-optical elements 65 and to reset the electro-optical elements 65 prior to loading new data into the electro-optical elements 65. Based on the data loaded into the electro-optical elements 65, each electro-optical element 65 is operable to selectively transfer the light received from a corresponding one of the color filters 55 to form the image for the current frame.

In one embodiment, the pixel data 90 is stored in the LCD controller 80. In another embodiment, the pixel data 90 is input to the LCD controller 80 from any type of memory device, such as a flash ROM, EEPROM, ROM, RAM or any other type of storage device. As used herein, the term “controller” includes any hardware, software, firmware, or combination thereof. As an example, the LCD controller 80 could include one or more processors that execute instructions and one or more memories that store instructions and data used by the processors. As another example, the LCD controller 80 could include one or more processing devices, such as microcontrollers, Field Programmable Gate Arrays (FPGAs), or Application Specific Integrated Circuits (ASICs), or a combination thereof.

In accordance with embodiments of the present invention, the LCD controller 80 selectively loads the pixel data 90 for an image frame into the individual electro-optical elements 65 to minimize image blurring. More specifically, the LCD controller 80 correlates each electro-optical element 65 with one of the light sources 20a, 20b and 20c. In addition, the LCD controller 80 operates in conjunction with the illumination drive circuit 45 to load data representing a portion of the image into the electro-optical elements 65 that are correlated with the light source 20a, 20b or 20c that is currently modulated by the illumination drive circuit 45 to reduce the intensity of light produced by that light source 20a, 20b or 20c.

In an exemplary embodiment, the LCD controller 80 correlates the electro-optical elements 65 with light sources 20a, 20b and 20c according to color. Each electro-optical element 65 is first correlated with the color of the color filter 55 that is optically coupled to that electro-optical element 65. For example, in FIG. 1, P1 in the top-left corner of the array is correlated with the color green, P2 is correlated with the color blue and P5 is correlated with the color red. All of the red electro-optical elements 65 are then correlated with the red light source 20a, all of the green electro-optical elements 65 are then correlated with the green light source 20b and all of the blue electro-optical elements 65 are then correlated with the blue light source 20c.

As a result, when the illumination drive circuit 45 modulates the red light source 20a to reduce the intensity of the red light produced by the red light source 20a, the LCD controller 80 loads pixel data 90 for a new image into the red electro-optical elements (e.g., elements P5 and P7). Since the red electro-optical elements 65 only pass red light (and not blue or green light), modulating the red light source 20a while loading data into the red electro-optical elements 65 allows the liquid crystal material associated with the red electro-optical elements to settle before being illuminated, thus reducing artifacts in the image. Likewise, when the illumination drive circuit 45 modulates the green light source 20b to reduce the intensity of the green light produced by the green light source 20b, the LCD controller 80 loads pixel data 90 for the new image into the green electro-optical elements (e.g., elements P1, P3, P6, P8, P9 and P10, and when the illumination drive circuit 45 modulates the blue light source 20c to reduce the intensity of the blue light produced by the blue light source 20c, the LCD controller 80 loads pixel data 90 for the new image into the blue electro-optical elements (e.g., elements P2, P4, P10 and P12). The illumination drive circuit 45 can selectively modulate each the light sources 20a, 20b and 20c to reduce or increase the intensity thereof in order to maintain a constant average intensity of light at each wavelength 30a, 30b and 30c to avoid the appearance of flickering or overall dimming of the screen.

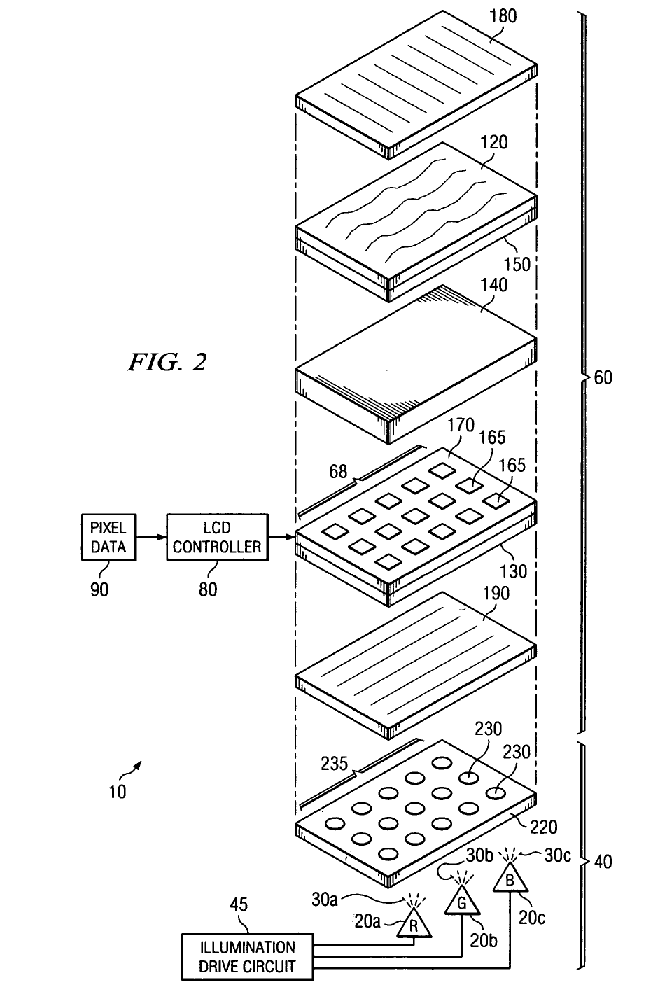

FIG. 2 is an exploded view of another exemplary liquid crystal display device 10 capable of reducing artifacts in images displayed on the display device 10, in accordance with embodiments of the present invention. The display device 10 again includes an illumination device 40 and a liquid crystal device 60. In addition, the illumination device 100 includes multiple light sources 20a, 20b and 20c, each operable to output light in a different wavelength range of the visible light spectrum 30a, 30b and 30c, respectively. For example, in one embodiment, light source 20a emits red light 30a, light source 20b emits green light 30b and light source 20c emits blue light 30c. The number of light sources 20a, 20b and 20c and the wavelength ranges produced by each light source 20a, 20b and 20c are dependent upon the particular application of the illumination device 40. In an exemplary embodiment, light sources 20a, 20b, 20c are LEDs. In other embodiments, light sources 20a, 20b, 20c include any type of device capable of producing light at a particular wavelength range within the visible light spectrum.

However, instead of mixing the light 30a, 30b and 30c to provide a uniform field of white light to a CFA (as in FIG. 1), the light sources 20a, 20b and 20c in FIG. 2 are individually optically coupled to a waveguide device 220. The waveguide device 220 is formed of one or more waveguides, each for optically coupling light from one of the light sources 20a, 20b or 20c to one or more optical apertures 230 of the waveguide device 220. As used herein, the term “optical aperture” refers to an opening, such as a hole, gap or slit through which light may pass. The optical apertures 230 are spatially arranged in a predetermined pattern 235 to produce a spatial pattern of light at different wavelengths. For example, the optical apertures 230 can be arranged in an array of rows and columns, an array of columns (“stripes”) or in a nonorthogonal pattern. The output of each optical aperture 230 of the waveguide device 220 is a respective beam of light at a wavelength 30a, 30b or 30c corresponding to one of the light sources 20a, 20b or 20c, respectively. The beams of light output from the optical apertures 230 are directed toward the liquid crystal device 60.

In one exemplary embodiment, the waveguide device 220 includes trunk waveguides (e.g., lightguides formed of optical fibers) and lateral waveguides, in which each trunk waveguide is optically coupled to one of the light sources 20a, 20b or 20c. In embodiments in which multiple light sources of a given wavelength are used, each of the light sources corresponding to a particular wavelength can be optically coupled to the same trunk waveguide or different trunk waveguides. Each lateral waveguide is optically coupled to one of the trunk waveguides, and each lateral waveguide defines an optical aperture 230 operable to emit light in a substantially uniform manner along the length of the lateral waveguide.

In another exemplary embodiment, the waveguide device 220 includes an optical substrate within which waveguides are defined as optical cavities. For example, in one embodiment, the optical substrate includes two sandwiched sheets of plastic (e.g., polyether-ether-keytone (PEEK) or other similar plastic material) having different indices of refraction on which patterns defining the optical cavities are embossed. Each optical cavity is optically coupled to one of the light sources 20a, 20b or 20c, and each optical cavity includes one or more optical branches optically coupled to one or more respective optical apertures 230 formed on a surface of the optical substrate. As such, each optical cavity and corresponding optical branches are directed through the optical substrate in a manner enabling optical coupling between the optical branches and the optical apertures 230.

In one embodiment, the optical cavity and associated optical branches for each light source 20a, 20b and 20c are formed within a single layer optical substrate such that there is no optical coupling between the optical cavities and associated branches for each light source. In another embodiment, the optical cavity and associated optical branches for each light source 20a, 20b and 20c are formed in different layers of the optical substrate to avoid any potential optical coupling therebetween.

FIG. 2 also provides a more detailed view of the liquid crystal device 60. As can be seen in FIG. 2, the liquid crystal device 60 includes a substrate 130 on which a two-dimensional array of pixel electrodes 165 are located. The pixel electrodes 165 are spatially arranged in a pattern 68 corresponding to the pattern 235 of optical apertures 230 in the waveguide device 220, such that each pixel electrode 165 is optically coupled to receive light from only one optical aperture 230. For example, in one embodiment, each optical aperture 230 optically couples light to only a single pixel electrode 165. In another embodiment, each optical aperture 230 optically couples light to a 1×N array of spatially adjacent pixel electrodes 165. In yet another embodiment, each optical aperture 230 optically couples light to an M×N array of spatially adjacent pixel electrodes 165.

Within the substrate 130 below or adjacent to the pixel electrodes 165 is located pixel drive circuitry 170 connected to drive the pixel electrodes 165. For example, in one embodiment, the pixel drive circuitry 170 includes a matrix of thin film transistors (TFTs) driven by row selector 70 and column selector 75, as shown in FIG. 1, for individually addressing each pixel electrode 165. Disposed above the substrate 130 is a transparent glass 120 coated with a layer of transparent electrically conductive material, such as indium tin oxide (ITO). The ITO layer serves as the common electrode 150 of the liquid crystal device 60. Encapsulated between the substrate 130 and the glass 120 is a layer 140 of liquid crystal material that reacts in response to electric fields established between the common electrode 150 and pixel electrodes 165. Adjacent an outer surface of the glass 120 is located a first polarizer 180 and adjacent an outer surface of the substrate 130 is located a second polarizer 190.

The pixel electrodes 165 in combination with pixel drive circuitry 170, common electrode 150, liquid crystal material 140 and polarizers 180 and 190 form the respective individual electro-optical elements (65, shown in FIG. 1) that define the pixels of an image displayed or projected by the display device 10. As described above, each electro-optical element is operable to selectively transfer the light received from a corresponding one of the optical apertures 230 to form the image. Depending on the voltages applied between the pixel electrodes 165 and common electrode 150, the liquid crystal material 140 reacts at each electro-optical element to either change or not change the polarization state of incoming light. Thus, the common electrode 150 is configured to receive a common electrode signal from the LCD controller 80 for the electro-optical elements and each pixel electrode 165 is configured to receive a respective pixel electrode signal including the pixel data 90 from the LCD controller 80 for modulating the liquid crystal material associated with the respective electro-optical element to form the image.

In one embodiment, the electro-optical elements allow light of a particular polarization to be transmitted or not transmitted. In another embodiment, the pixel electrodes 165 can be driven with voltages that create a partial reaction of the liquid crystal material 140 so that the electro-optical element is in a non-binary state (i.e., not fully ON or OFF) to produce a “gray scale” transmission. For example, the voltages that create a partial reaction of the liquid crystal material 140 are typically produced by applying signals on the pixel electrode 165 and common electrode 150 that not fully in or out of phase, thereby creating a duty cycle between zero and 100 percent, as understood in the art.

In accordance with embodiments of the present invention, the LCD controller 80 selectively loads the pixel data 90 for an image frame into the individual pixel electrodes 165 to minimize image blurring. More specifically, the LCD controller 80 correlates each pixel electrode 165 with one of the light sources 20a, 20b and 20c. In addition, the LCD controller 80 operates in conjunction with the illumination drive circuit 45 to load data representing a portion of the image into the pixel electrodes 165 that are correlated with the light source 20a, 20b or 20c that is currently modulated by the illumination drive circuit 45 to reduce the intensity thereof.

In an exemplary embodiment, the LCD controller 80 correlates the pixel electrodes 165 with light sources 20a, 20b and 20c according to color. Each pixel electrode 165 is correlated with the color of light 30a, 30b or 30c that is optically coupled to that pixel electrode 165 through a corresponding optical aperture 230 on the waveguide device 220. Then, as in FIG. 1, all of the red pixel electrodes 165 are correlated with the red light source 20a, all of the green pixel electrodes 165 are correlated with the green light source 20b and all of the blue pixel electrodes 165 are correlated with the blue light source 20c.

Thereafter, when the illumination drive circuit 45 modulates the red light source 20a to reduce the intensity of the red light produced by the red light source 20a, the LCD controller 80 loads pixel data 90 for a new image into the red pixel electrodes 165. Since the red pixel electrodes 165 receive only red light (and not blue or green light), modulating the red light source 20a while loading data into the red pixel electrodes 165 allows the liquid crystal material associated with the red electro-optical elements to settle before being illuminated, thus reducing artifacts in the image. Likewise, when the illumination drive circuit 45 modulates the green light source 20b to reduce the intensity of the green light produced by the green light source 20b, the LCD controller 80 loads pixel data 90 for the new image into the green pixel electrodes 165, and when the illumination drive circuit 45 modulates the blue light source 20c to reduce the intensity of the blue light produced by the blue light source 20c, the LCD controller 80 loads pixel data 90 for the new image into the blue pixel electrodes 165. Again, the illumination drive circuit 45 can selectively modulate the light sources 20a, 20b and 20c to maintain a constant average intensity of light at each wavelength 30a, 30b and 30c to avoid the appearance of flickering or overall modulating of the screen.

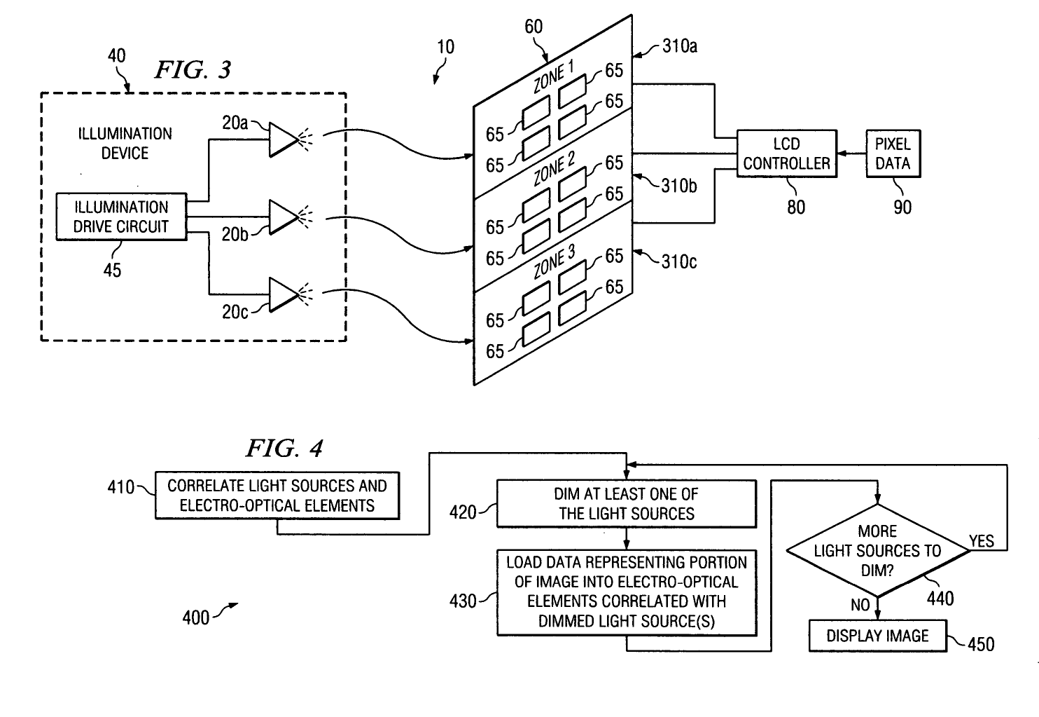

FIG. 3 is a pictorial representation of another exemplary display device 10 capable of reducing artifacts in images displayed on the display device 10, in accordance with embodiments of the present invention. The display device 10 again includes an illumination device 40 and a liquid crystal device 60. In addition, the illumination device 100 includes multiple light sources 20a, 20b and 20c, each operable to output light in one or more wavelength ranges of the visible light spectrum. However, in FIG. 3, each light source 20a, 20b and 20c represents multiple LED's. Thus, the display device 10 in FIG. 3 can include a CFA, as shown in FIG. 1, for each light source 20a, 20b and 20c, or can utilize a separate waveguide device, as shown in FIG. 2, for each light source 20a, 20b and 20c.

Regardless of the specific implementation for the color display, the electro-optical elements 65 within the liquid crystal device 60 are divided into zones 310a, 310b and 310c. The electro-optical elements 65 within each zone 310a, 310b and 310c are optically coupled to receive light from one of the light sources 20a, 20b or 20c. In accordance with embodiments of the present invention, the LCD controller 80 loads data into the electro-optical elements 65 per zone 310a, 310b or 310c.

More specifically, the LCD controller 80 correlates all of the electro-optical elements 65 within each zone 310a, 310b and 310c with the light source 20a, 20b and 20c that illuminates that zone 310a, 310b and 310c, respectively. The LCD controller 80 then operates in conjunction with the illumination drive circuit 45 to load data representing a portion of the image into the electro-optical elements 65 that are correlated with the light source 20a, 20b or 20c that is currently modulated to reduce the intensity thereof by the illumination drive circuit 45.

In one exemplary embodiment, the illumination drive circuit 45 simultaneously modulates all of the LED's for a particular light source 20a, 20b or 20c to reduce the intensity thereof to enable the LCD controller 80 to update all of the electro-optical elements 65 in the zone 310a, 310b or 310c associated with that light source 20a, 20b or 20c, respectively. For example, assuming light source 20a includes a white LED, a combination of red, green and blue LEDs or a combination of a white LED with red, green and blue LEDs, the illumination drive circuit 45 would modulate all of the LEDs associated with light source 20a to reduce the intensity of each LED within light source 20a while the LCD controller 80 loads data into the electro-optical elements 65 within zone 310a.

In another exemplary embodiment, the LCD controller 80 individually correlates the electro-optical elements 65 with not only light sources 20a, 20b and 20c, but also LED's within the light sources 20a, 20b and 20c, according to color. For example, depending on the particular implementation, each electro-optical element 65 within each zone 310a, 310b and 310c is correlated with the color of light that is optically coupled to that electro-optical element 65 through a CFA or through a waveguide device. As an example, all of the red electro-optical elements 65 within zone 310a are correlated with a red LED within light source 20a, all of the green electro-optical elements 65 within zone 310a are correlated with a green LED within light source 20a and all of the blue electro-optical elements 65 within zone 310a are correlated with a blue LED within light source 20a, and so on for each zone 310b and 310c.

Thereafter, when the illumination drive circuit 45 modulates the red LED to reduce the intensity of red light produced by light source 20a, the LCD controller 80 loads pixel data 90 for a new image into the red electro-optical elements 65 within zone 310a. Likewise, when the illumination drive circuit 45 modulates the green LED to reduce the intensity of green light produced by light source 20a, the LCD controller 80 loads pixel data 90 for the new image into the green electro-optical elements 65 within zone 310a, and when the illumination drive circuit 45 modulates the blue LED to reduce the intensity of blue light produced by light source 20a, the LCD controller 80 loads pixel data 90 for the new image into the blue electro-optical elements 65 within zone 310a, and so on for each zone 310b and 310c. Again, the illumination drive circuit 45 can selectively modulate the LED's within the light sources 20a, 20b and 20c to maintain a constant average intensity of light at each wavelength to avoid the appearance of flickering or overall dimming of the screen.

FIG. 4 is a flow chart illustrating an exemplary process 400 for correlating updates to pixels on a display with illumination of the pixels on the display to reduce artifacts in images displayed on the display, in accordance with embodiments of the present invention. Initially, at block 410, the light sources within the display are correlated with individual electro-optical elements defining pixels of an image. Thereafter, to update the pixels with new data representing a new image, at block 420, at least one of the light sources is modulated to reduce the intensity thereof. While the light source(s) are modulated, at block 430, data representing a portion of the new image is loaded into the electro-optical elements that are correlated with the modulated light source(s). At block 440, this process is repeated for each of the light sources in the display until all of the electro-optical elements have been updated with new data. Once the new data is loaded into all of the electro-optical elements, at block 450, the image is displayed.

The innovative concepts described in the present application can be modified and varied over a wide rage of applications. Accordingly, the scope of patented subject matter should not be limited to any of the specific exemplary teachings discussed, but is instead defined by the following claims.

We claim:

1. A display device, comprising:
an illumination device including light sources for emitting light and an illumination drive circuit operable to individually modulate each of said light sources;
electro-optical elements defining pixels of an image, each of said electro-optical elements being optically coupled to receive light correlated with one of said light sources; and
a controller operable to load data representing a portion of the image into ones of said electro-optical elements correlated with a modulated one of said light sources modulated to reduce the intensity thereof.

2. The display device of claim 1, wherein each of said light sources emits light at a different respective wavelength.

3. The display device of claim 2, wherein said illumination drive circuit is operable to maintain a constant average intensity of light at each said respective wavelength.

4. The display device of claim 2, wherein said illumination device further includes a respective waveguide for each of said light sources, each of said waveguides defining respective optical apertures spatially arranged in a respective predetermined pattern to produce a respective spatial pattern of light, and wherein said controller is operable to load data into said electro-optical elements optically coupled to receive said spatial pattern of light corresponding to said modulated one of said light sources.

5. The display device of claim 4, wherein each said respective waveguide includes a respective trunk waveguide for said respective one of said light sources and lateral waveguides defining said optical apertures that are optically coupled to said respective trunk waveguide.

6. The display device of claim 4, wherein each said respective waveguide is defined as an optical cavity within an optical substrate, said optical substrate having said optical apertures formed on a surface thereof, each said respective optical cavity being optically coupled to one or more of said optical apertures.

7. The display device of claim 4, wherein said electro-optical elements are spatially arranged in a plurality of zones and said light sources include sets of light sources, each optically coupled to illuminate one of said zones.

8. The display device of claim 4, wherein:
said light sources are light emitting diodes including a first light emitting diode emitting red light, a second light emitting diode emitting green light and a third light emitting diode emitting blue light;
said controller is operable to load data into said electro-optical elements that are optically coupled to receive said red light when said first light emitting diode is modulated;
said controller is operable to load data into said electro-optical elements that are optically coupled to receive said green light when said second light emitting diode is modulated; and
said controller is operable to load data into said electro-optical elements that are optically coupled to receive said blue light when said third light emitting diode is modulated.

9. The display device of claim 2, further comprising:
an array of color filters, each for transmitting light at one of a predetermined number of wavelength ranges and spatially arranged in a predetermined pattern to produce a spatial pattern of light at wavelengths corresponding to said predetermined pattern, and wherein each of said light sources emits light at one of said wavelength ranges to produce a uniform field of light optically received at said color filters.

10. The display device of claim 9, wherein:
said electro-optical elements are spatially arranged in said predetermined pattern to receive said spatial pattern of light; and
said controller is operable to load data into said electro-optical elements that are optically coupled to receive light at one of said wavelength ranges corresponding to said modulated one of said light sources.

11. The display device of claim 10, wherein:
said light sources are light emitting diodes including a first light emitting diode emitting red light, a second light emitting diode emitting green light and a third light emitting diode emitting blue light;
said color filters include green filters operable to transmit green light, blue filters operable to transmit blue light and red filters operable to transmit red light;
said controller is operable to load data into said electro-optical elements that are optically coupled to receive said red light when said first light emitting diode is modulated;
said controller is operable to load data into said electro-optical elements that are optically coupled to receive said green light when said second light emitting diode is modulated; and
said controller is operable to load data into said electro-optical elements that are optically coupled to receive said blue light when said third light emitting diode is modulated.

12. The display device of claim 9, wherein:
said electro-optical elements are spatially arranged in a plurality of zones;
said array of color filters includes a respective array portion for each of said zones; and
said controller is operable to load data into said electro-optical elements within one or more of said zones that are optically coupled to receive light at one of said wavelength ranges corresponding to said modulated one of said light sources.

13. The display device of claim 1, wherein:
said electro-optical elements are spatially arranged in a plurality of zones;
each of said light sources is optically coupled to illuminate one of said zones; and
said controller is operable to load data into said electro-optical elements within said zone that is optically coupled to receive light from said modulated one of said light sources.

14. The display device of claim 1, wherein said electro-optical elements comprise liquid crystal material, and wherein said electro-optical elements further comprise:
a common electrode configured to receive a common electrode signal for said electro-optical elements; and
a respective pixel electrode for each of said electro-optical elements, each of said respective pixel electrodes configured to receive a respective pixel electrode signal containing said data representing a pixel of said image, each said pixel electrode signal modulating said liquid crystal material associated with said respective electro-optical element to form said image.

15. A method for correlating updates to pixels on a display with illumination of the pixels on the display, said method comprising:
correlating light sources with electro-optical elements defining pixels of an image;
modulating one of said light sources to reduce the intensity thereof; and
loading data representing a portion of the image into ones of said electro-optical elements correlated with said modulated one of said light sources.

16. The method of claim 15, wherein each of said light sources emits light at a different respective wavelength, and further comprising:
maintaining a constant average ratio of light at each said respective wavelength.

17. The method of claim 15, wherein said loading data further includes:
providing a respective waveguide for each of said light sources, each of said waveguides defining respective optical apertures spatially arranged in a respective predetermined pattern to produce a respective spatial pattern of light; and
loading data into said electro-optical elements optically coupled to receive said spatial pattern of light corresponding to said modulated one of said light sources.

18. The method of claim 15, wherein said light sources are light emitting diodes including a first light emitting diode emitting red light, a second light emitting diode emitting green light and a third light emitting diode emitting blue light, and wherein said loading data further includes:
loading data into said electro-optical elements that are optically coupled to receive said red light when said first light emitting diode is modulated;
loading data into said electro-optical elements that are optically coupled to receive said green light when said second light emitting diode is modulated; and
loading data into said electro-optical elements that are optically coupled to receive said blue light when said third light emitting diode is modulated.

19. The method of claim 15, further comprising:
providing an array of color filters, each for transmitting light at one of a predetermined number of wavelength ranges and spatially arranged in a predetermined pattern to produce a spatial pattern of light at wavelengths corresponding to said predetermined pattern; and
providing that each of said light sources emits light at one of said wavelength ranges to produce a uniform field of light optically received at said color filters.

20. The method of claim 19, wherein said electro-optical elements are spatially arranged in said predetermined pattern to receive said spatial pattern of light, and wherein said loading further includes:
loading data into said electro-optical elements that are optically coupled to receive light at one of said wavelength ranges corresponding to said modulated one of said light sources.

21. The method of claim 15, wherein said electro-optical elements are spatially arranged in a plurality of zones and each of said light sources is optically coupled to illuminate one of said zones, and wherein said loading data further includes:
loading data into said electro-optical elements within said zone that is optically coupled to receive light from said modulated one of said light sources.
